(19) United States
(12) Patent Application Publication
(10) Pub. No.: US 2011/0011886 A1
(43) Pub. Date: Jan. 20, 2011

(54) Portable data collection sterilization dispenser and holder assembly

(76) Inventors: Harold Zaima, Bloomfield Hills, MI (US); Bradley Ahlgren, Bloomfield Hills, MI (US)

Correspondence Address: CLARK HILL, P.C., 500 WOODWARD AVENUE, SUITE 3500, DETROIT, MI, 48226, US

(21) Appl. No.: 12/804,172

(22) Filed: Jul. 14, 2010

Related U.S. Application Data
(60) Provisional application No. 61/270,866, filed on Jul. 14, 2009.

(51) Int. Cl. B67D 7/32

(52) U.S. Cl. 222/1; 222/23; 222/52; 222/183; 222/175

(57) ABSTRACT

A dispenser assembly is provided for dispensing disinfectant to a user upon the detection of a signal. The dispenser assembly includes a main housing defining a cavity and a container disposed within the cavity and releasably secured to the main housing. The container contains a fluid therewithin. An electronics unit is coupled to the main housing and includes a sensor for detecting the signal. The electronics unit includes a controller for producing a reminder alert in response to the detection of the signal to remind the user to activate the dispenser assembly to dispense fluid from the container.

### CROSS-REFERENCE TO RELATED APPLICATION

This application claims the benefit of U.S. Provisional Application No. 61/270,866, filed Jul. 14, 2009.

### BACKGROUND

1. Field of the Invention

The invention relates to portable personal dispensers containing disinfectants. More particularly, the invention relates to a portable dispenser assembly having an electronic alert and data collection system for reminding a user to dispense disinfectant, and having the capability to monitor time, date, frequency, and location of use of the dispenser assembly.

2. Description of Related Art

Various infectious diseases such as SARS, Avian Flu, HIV, Herpes, MRSA, and most recently, H1N1 influenza, have had a significant impact on the world population. With the continued increase of world travel, such infectious diseases are able to spread more readily from region-to-region and country-to-country, and this pace will only continue to accelerate. Early detection of such infectious diseases and prevention of transmittal are two ways to prevent a widespread epidemic. Also, these infectious diseases are capable of being spread in medical facilities, restaurants, and other public facilities. But in order to stop transmission, the infection must be eradicated at the most widely noted point of transmission. It is well-known that the greatest medium of communication of any bacteria or influenza is through touch. Primarily, this touch is by the hands. Therefore, cleansing the hands frequently and at the appropriate time is essential in the prevention of infectious diseases, most importantly in hospitals where bacteria and pathogens are abundant and where medical practitioners are constantly exposed to such pathogens through contact with patients and the general public.

One method that is available to destroy illness causing pathogens before infection can set in or be transmitted is the use and application of products including anti-microbacterial agents with ethyl alcohol gels, foam, or liquids. Such products are readily available, are effective in eradicating infectious pathogens from spreading, and kill bacteria upon contact. However, merely having these bacteria killing substances are insufficient. The product must be used, used often, and more importantly used at the correct time. As such, the product must be readily available and the user must use the product at the correct time. Thus, for any disinfecting product to work, the disinfecting substance must be effective, the user must have immediate and convenient access to a device that dispenses the product, and most importantly the disinfecting substance must be applied at the appropriate time.

Currently, medical facilities have multiple locations where medical practitioners can properly cleanse their hands with soap and water. In addition, many medical facilities have stations with antibacterial dispensing containers mounted to the walls. Further, medical practitioners may carry relatively small canisters in their pockets to sterilize their hands prior to each patient examination in order to prevent the transmission of infectious disease. The general public has fewer opportunities to properly and constantly cleanse their hands, with the most common available means being gel pump soap systems found in restrooms of stores and restaurants. Though helpful, none of these methods have proven to be truly effective. In hospitals, the location for properly cleansing the hands with antibacterial soap is always not immediately available. And even if they are available, frequent washing of the hands causes hands to become dry and chaffed resulting in discomfort to both the medical practitioner and the patient. In the case of gel, liquid, and foam hand sanitizing stations, it must be readily available when the medical practitioner needs or wants to use it. Even if available, often times the medical practitioner finds that the disinfectant at the stations is empty, therefore, constant monitoring and refilling are required. The small canisters are somewhat effective, however, medical practitioners tends to set them down whereby misplacing them. In order for the cleansing agent to be effective, the method of cleansing the hands within the hospital or in public locations must be convenient and readily accessible when the user thinks of the need for use and more importantly to prompt use there must be an alert that reminds the user to use the cleansing agent and that does not turn off until the disinfectant is used, thereby assuring usage.

A portable dispenser assembly is provided that is made readily available to a user, such as a medical practitioner or an individual consumer, by being clipped to their person and/or to something they always carry, such as a handbag or backpack. The portable dispenser assembly is equipped with an electronic reminder that alerts the user wearing or carrying the dispensing assembly with one or more of a visual reminder, an audible sound, and a vibration to remind the user to dispense the disinfectant. The portability, ease of use, and electronic reminder that does not turn off until used ensure frequent usage at the appropriate time for medical practitioners and facilitate more frequent usage among lay persons to help eradicate illness-causing pathogens encountered in everyday life to prevent the spread of infectious disease and/or influenza. Having the medical practitioner wear the device also serves as a visual reminder for the patient to ensure use of the disinfectant before examination. Thus, the four most important aforementioned parameters are achieved forcing the use of the disinfecting substance by virtue of having a convenient body-worn device containing a proven effective disinfectant and a reminder that continues to remind until the device is used at the appropriate time. As a result, the transmission of infectious diseases within medical facilities and among the general public is greatly reduced, thereby lowering medical costs and reducing inpatient stays. Also, medical facilities will be able to monitor the use of these devices to validate their effectiveness and to evaluate the necessity of future programs, such as training or other means of awareness, to increase their effectiveness. A display on the device can be a light emitting diode (LED) or other display which allows the device to display the date and time, to advertise by, for example, displaying the name of the medical facility, or to display the name of the practitioner or owner of the device, or provider of the disinfectant.

This invention allows the user to carry the device on its person or personal item so that they are not constantly looking for a hand washing station or wall-mounted sterilizing units, which are often empty even if located. In addition, this invention has an integrated electronic device to remind the user the need for use at the appropriate time as well as allow the medical facility and/or disinfectant manufacturer to collect valuable data that can be used to improve upon the program as well as provide substantiation of use and other valuable and useful information. This invention accomplishes this in any number of ways. For a medical practitioner this device would remind the doctor, physician's assistant, nurse, or nurse's assistant to use the device immediately before examining the patient through the use of an audible, visual, and/or physical (vibrating) signal. Because the alert will not turn off until the disinfectant is dispensed, it forces the medical practitioner to use the disinfectant as well as provide the patient the awareness that it must be used prior to examination providing a fairly failsafe system to ensure use. For a lay consumer, the device can be set up to beep, light up, and/or physically activate on set or random intervals. For advanced models, the device can also be attached with a sensor whereby the sensor detects the presence of infectious pathogens and sets off an alarm upon detection of the pathogen prompting use and/or evacuation. Further, it is known that many airborne pathogens are most widely transmitted and present immediately after a cough or a sneeze. An additional feature of the advanced version of this device would have a mechanism that detects nearby coughs and sneezes by the sounds and/or change in atmospheric pressure whereby setting off the reminder alarm to use the device and/or evacuate from the immediate premise.

### SUMMARY

According to one aspect of the invention, a dispenser assembly is provided for dispensing disinfectant to a user upon the detection of a signal. The dispenser assembly includes a main housing defining a cavity, a container disposed within the cavity and releasably secured to the main housing, the container containing fluid therewithin, and an electronics unit coupled to the main housing and including a sensor for detecting the signal. The electronics unit includes a controller for producing a reminder alert in response to the detection of the signal to remind the user to activate the dispenser assembly to dispense fluid from the container.

According to another aspect of the invention, a system includes an electronic emitter adapted to be mounted in a fixed location, the electronic emitter generating a signal, and a dispenser assembly including a main housing and a container filled with fluid. The main housing defines a chamber for receiving an electronics unit having a sensor for sensing the signal from the electronic emitter. The electronics unit also includes a controller for producing a reminder alert in response to the sensing of the signal to remind a user to dispense fluid from the container.

According to yet another aspect of the invention, a method is provided for reminding a user to dispense fluid from a portable dispenser assembly utilizes a main housing, a container filled with fluid and having a depression button, an electronics unit including a sensor, and an electronic emitter producing a signal. The method includes the steps of activating the electronic emitter to generate the signal; sensing the signal with the sensor of the portable dispenser assembly; generating the reminder alert to remind the user to dispense the fluid from the dispenser assembly; pressing the depression button to dispense the fluid; and terminating the reminder alert once the fluid has been dispensed.

### BRIEF DESCRIPTION OF THE DRAWINGS

The invention will be readily appreciated as the same becomes better understood by reference to the following detailed description when considered in connection with the accompanying drawings wherein:

FIG. 1 is a perspective view of a dispenser assembly according to a first embodiment of the invention;

FIG. 2 is an exploded perspective view of the dispenser assembly in a first embodiment of the invention including a main housing and a canister;

FIG. 3 is a top view of the main housing for the dispenser assembly in a first embodiment of the invention;

FIG. 4 is a rear view of the dispenser assembly in a first embodiment of the invention;

FIG. 5 is a side view of the dispenser assembly in a first embodiment of the invention;

FIG. 6 is a cross-sectional view taken along line 6-6 in FIG. 1 of the dispenser assembly in a first embodiment of the invention;

FIG. 7 is a schematic diagram of an electronic reminder alert and data collection system;

FIG. 8A is an oblique view of an electronic emitter assembly for emitting a signal to be received by the dispenser assembly;

FIG. 8B is a front view of a door including the electronic emitter assembly fixedly mounted to a door jam to create an electronic curtain in a passageway underneath the door jam;

FIG. 8C is a fragmentary perspective view of a room including an electronic emitter coupled to a power source and emitting a signal for sensing by the dispenser assembly;

FIG. 9 is a front perspective view of a dispenser assembly in a second embodiment of the invention;

FIG. 10 is a rear perspective view of the dispenser assembly in a second embodiment of the invention;

FIG. 11 is an exploded perspective view of the dispenser assembly in a second embodiment of the invention;

FIG. 12 is a top view of the dispenser assembly in a second embodiment of the invention;

FIG. 13 is a side view, partially cut away, of the dispenser assembly in a second embodiment of the invention; and

FIG. 14 is a cross-sectional view of the dispenser assembly taken along lines 14-14 in FIG. 9.

### DETAILED DESCRIPTION OF THE EMBODIMENTS

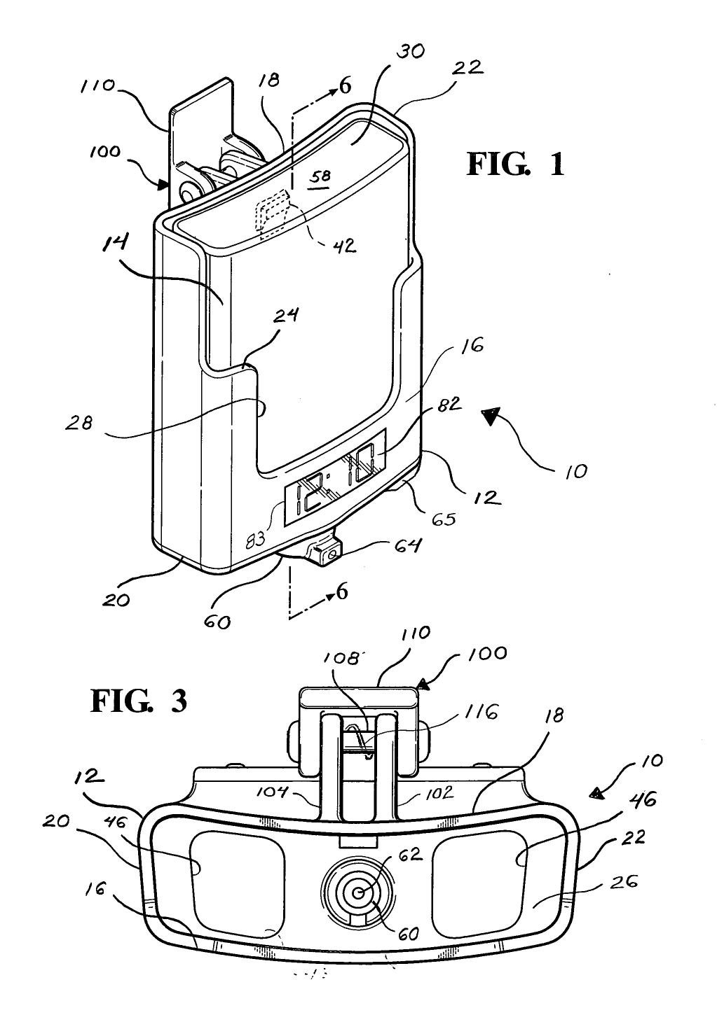

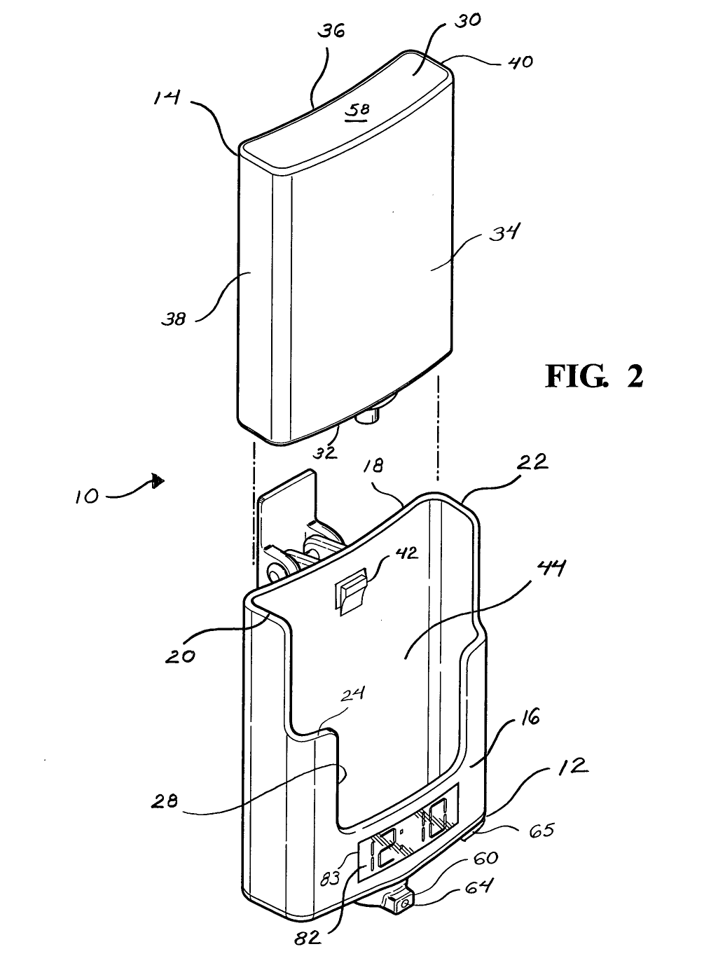

Referring to FIGS. 1 through 3, a dispenser assembly, generally shown at 10, according to a first embodiment of the invention includes a main housing 12 and a container 14. The main housing 12 includes a front wall 16, a back wall 18, and side walls 20, 22 each extending between the front wall 16 and the back wall 18. The front wall 16 and a portion of the side walls 20, 22 in one embodiment are cut out to form an upper edge 24 having an irregular shape. In one embodiment, each of the front 16 and back 18 walls is generally curved. The main housing 12 also includes a bottom wall 26. The front wall 16, the back wall 18, the side walls 20, 22, and the bottom wall 26 together define a cavity 28.

It is contemplated that the particular shape, size, and configuration of the main housing 12 may vary. In one embodiment, the main housing 12 may be a claw-type holder. The main housing 12 can be produced from any of numerous materials including, but not limited to, metal or a thermoplastic material. The thermoplastic material may be an anti-bacterial resin such as IonArmour, Masterbatch, or any of a variety of commercially available anti-bacterial resins.

The container 14 is received within the cavity 28 of the main housing 12. The container 14 includes an upper wall 30 and a lower wall 32. The container 14 also includes four sides 34, 36, 38, 40 each extending between the upper 30 and lower 32 walls. In one embodiment, the contour of the front 34 and back 36 sides of the container 14 is complementary to the curvature of the front 16 and back 18 walls of the main housing 12 to ensure a proper fit when the container 14 is placed inside the cavity 28 of the main housing 12. It is, however, appreciated that the container 14 may be any of numerous shapes including, but not limited to, cylindrical-shaped, oval-shaped, or crescent-shaped.

The container 14 is secured to the main housing 12 to prevent the inadvertent release of the container 14. The main housing 12 includes a tab 42 formed along a forward surface 44 of the back wall 18. The tab 42 engages a recessed portion formed along the back side 36 of the container 14 so that the container 14 is securely held within the cavity 28 of the main housing 12. When the container 14 is empty, it is necessary to replace the existing container 14 with a new container 14. In order to release the container 14, a user inserts a finger or a similarly-shaped object through at least one aperture 46 formed along the bottom wall 26 of the main housing 12 and pushes against the container 14 to disengage the tab 42 from the recessed portion. As a result, the container 14 is no longer secured to the main housing 12. The tab 42, which is generally tongue-shaped, includes a bottom portion that is attached to the back wall 18 such that the tab 42 flexes back when the container 14 is removed from the main housing 12. In another embodiment, the side walls 20, 22 of the main housing 12 could be formed at a height lower than that of the container 14 which allows the user to grab the container 14 for easy removal and replacement.

The container 14 includes an interior 48 that is configured to contain a fluid. The fluid may include liquids, gels, lotions, and foams, such as disinfectants, and other fluids and fluid-like substances. The container 14 may be pressurized or non-pressurized depending upon the particular fluid that is utilized.

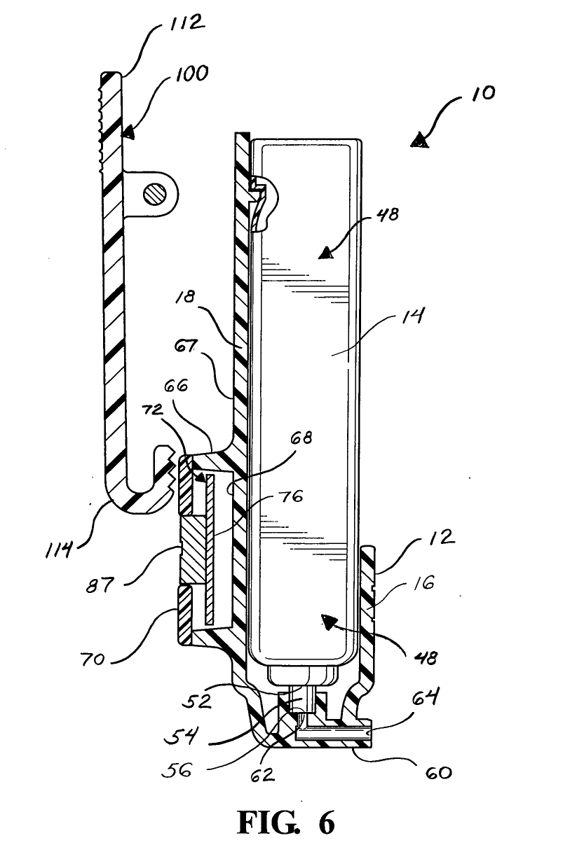

Referring to FIG. 6, the container 14 in one embodiment includes an intake tube, a pump mechanism 52, and a stem 54 disposed within the interior 48 for selectively forcing fluid out of the container 14, as is well-known to those of ordinary skill in the art. The stem 54 is in fluid communication with the interior 48 of the container 14 such that fluid is able to selectively exit the container 14 through an open end 56 of the stem 54. The container 14 includes a depression button 58 (shown in FIGS. 1 and 3) which is pressed downwardly by a user to activate the pump mechanism 52 and force the fluid out of the container 14 through the open end 56 of the stem 54.

Referring again to FIG. 6, the main housing 12 includes a nozzle 60 extending out from the bottom wall 26 and in fluid communication with the stem 54 to selectively eject the fluid from the dispenser assembly 10. The nozzle 60 includes an inlet 62 that is coupled to the open end 56 of the stem 54 to transfer fluid from the interior 48 of the container 14 to the nozzle 60. The nozzle 60 also includes a fluid discharge aperture 64 through which fluid is expelled upon activation of the dispenser assembly 10. It is appreciated that the nozzle 60 may in the alternative be integrated into the main housing 12. Alternatively, the nozzle 60 may have wings that act as tabs which allow the nozzle 60 to be interchanged into the main housing 12.

The container 14 is metered such that fluid is dispensed only when the depression button 58 of the container 14 is fully pressed down. Fully pressing the container 14 resets the container 14 to ensure dispensing of fluid. The quantity of fluid in the container 14 and the specific metered dosage thereof may be calibrated such that the user will only have to replace the container 14 on a weekly basis. The dispenser assembly 10 includes a metering adjustment device which ensures that each dispensing of the fluid can be properly adjusted and metered to prevent either too much or too little fluid from being dispensed at one time. The metering adjustment device may be a material that is positioned at the bottom of the main housing 12 that limits how far the container 14 can be depressed, thereby controlling the amount of fluid that is dispensed. In another embodiment, the metering adjustment device includes an adjustable threaded stopper wherein the position of the stopper can be adjusted to ensure that the container 14 bottoms out against the stopper at the right metering position.

The dispenser assembly 10 may include a counter that counts the number of times that fluid has been dispensed. Each time a new container 14 is inserted into the main housing 10, the counter resets and begins to count the number of times that the dispenser assembly 10 has been used. Once the counter reaches a predetermined number, a warning alert sounds to notify the user that it is time to replace the container 14. In the alternative, the warning alert may include a device that is built into the container 14 that produces an audible spitting sound when the fluid level is low.

Once the fluid has run out, the empty container 14 is replaced with a full container 14. In an alternative embodiment, the container 14 may include a cover selectively covering a refill opening. To refill the container 14, the cover is moved out of the way and fluid is added via the refill opening.

In one embodiment, a light source 65 is disposed along the bottom wall 26 of the main housing 12, as shown in FIGS. 1 and 3. The light source 65 may be an ultraviolet, infrared, or similar light which allows a user to check the effectiveness of the dispenser assembly 10 by shining a light onto the area of fluid application to allow the user to ensure the cleanliness of the area of fluid application.

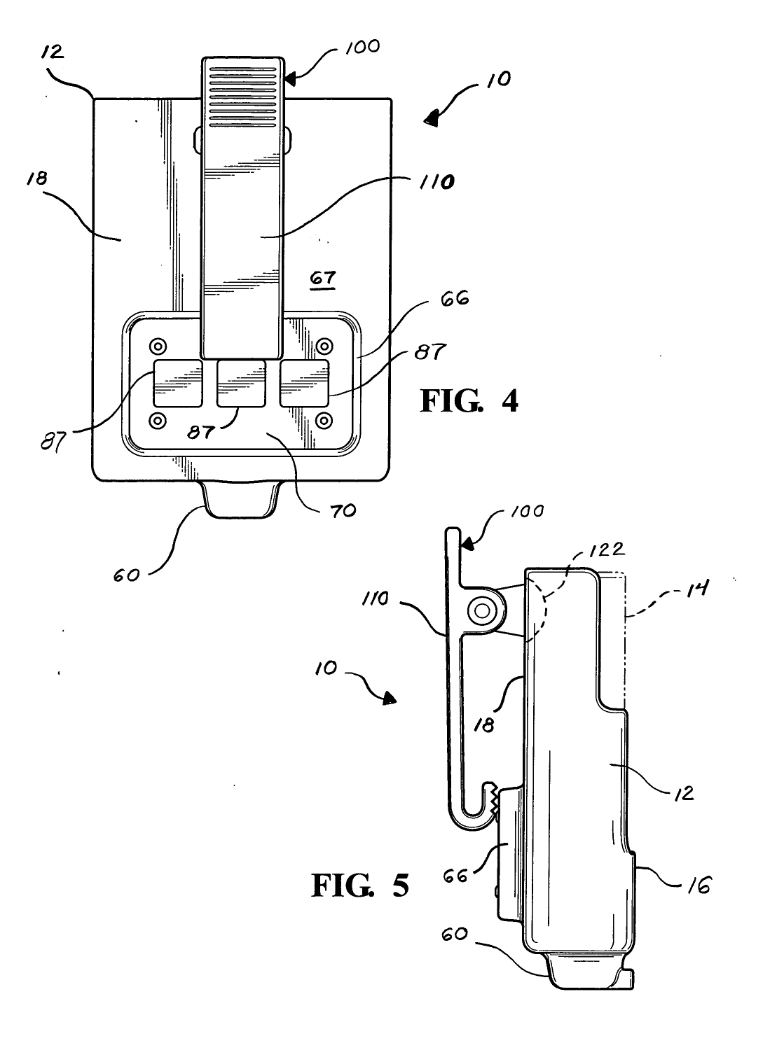

Referring to FIGS. 4 through 6, the dispenser assembly 10 includes a flange 66 formed along an outboard surface 67 of the back wall 18 of the main housing 12. The flange 66 and the back wall 18 of the main housing 12 define a chamber 68. It is appreciated that the particular location of the chamber 68 relative to the main housing 12 may vary. The chamber 68 is selectively closed by a removable cover 70.

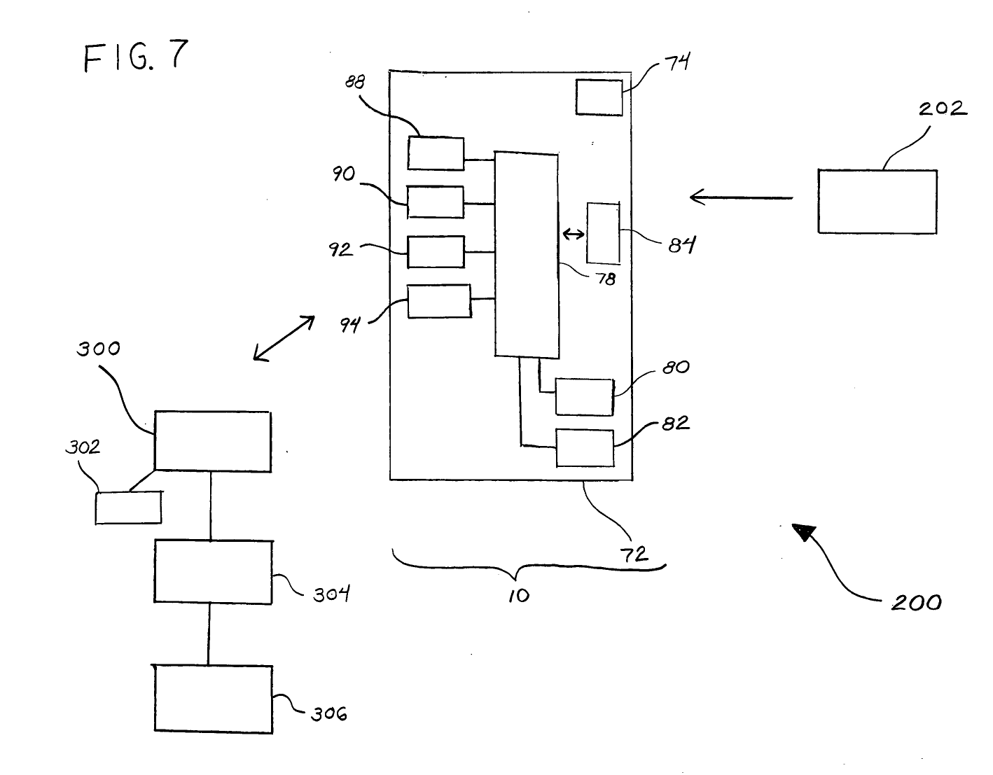

Referring to FIGS. 6 and 7, an electronics unit, generally indicated at 72, is disposed within the chamber 68 for sending a reminder alert to the user and communicating information to the user regarding the dispenser assembly 10. The electronics unit 72 also allows for the collection of data through a wireless connection or a wired connection, such as an Ethernet system. The electronics unit 68 includes a power source 74 positioned in the chamber 68 for providing power, a printed circuit board 76 connected to the power source 74 for distributing power, a controller 78 connected to the power source 74, a sensor 80 for sensing a signal, a transmitter 82 for transmitting a signal, and a memory 84. Information may be transmitted from the dispenser assembly 10 by a wireless connection or information may be downloaded from the dispenser assembly 10 via a USB connector.

An LED display 86 (shown in FIG. 1) is connected to the controller 78 and is capable of displaying alphanumeric characters, graphics, images, and the like through a screen window 83 formed along an outer surface of the main housing 12. In one embodiment, the LED display 86 is positioned along the front wall 16 of the main housing 12. It is, however, appreciated that the LED display 86 may be found in any of various locations on the main housing 12. Referring back to FIGS. 6 and 7, the dispenser assembly 10 also includes a speaker 88, a vibrating mechanism 90, and a clock 92 each operably coupled to the controller 78. At least one button 87 is coupled to the printed circuit board 76 and extends through the removable cover 70.

The electronics unit 72 provides a reminder alert that reminds the user to dispense disinfectant at any of numerous predetermined times or locations. The reminder alert could be a light, an audible alarm from the speaker 88, a vibration initiated by the vibrating mechanism 90, or a combination of more than one of these alerts. The reminder alert is only turned off when the container 14 has been fully pressed and the properly metered amount of fluid has been expelled. The user would have the ability to select which one or more of the light, audible alarm, and vibration to use for the reminder alert. But at least one of the reminder alerts must remain active during use. Only an authorized operator would have the ability to turn off all three of the reminder alerts for a user.

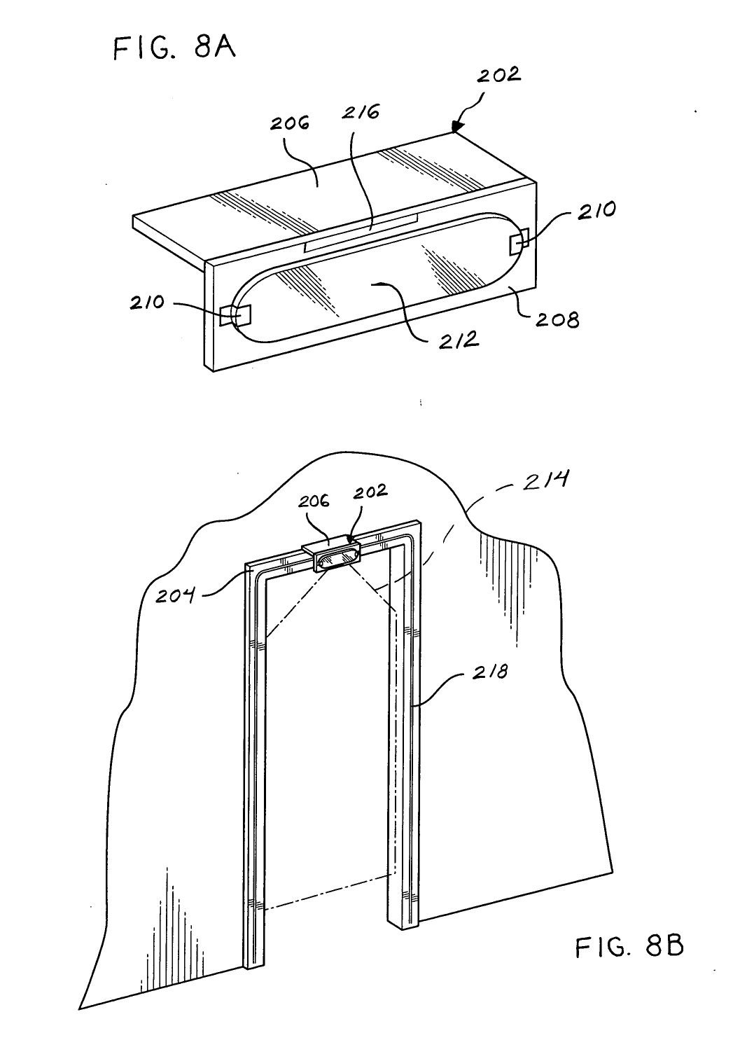

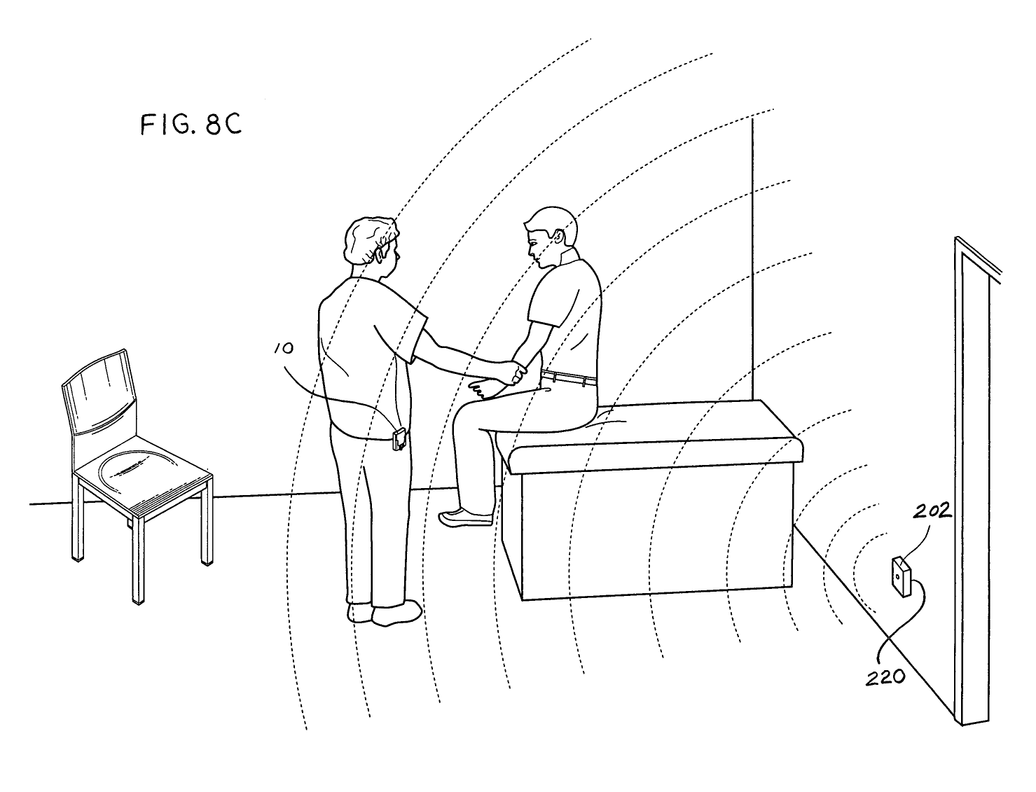

Referring to FIGS. 7 through 8c, an electronic reminder and data collection system 200 for producing the reminder alert includes the dispenser assembly 10 and an electronic emitter, generally indicated at 202. The electronic emitter 202 emits a signal, which may be an infrared signal, a radio frequency (RF) signal, or other electronic signal. In one embodiment, the electronic emitter 202 is adapted to be secured to a door jam 204, as shown in FIG. 8B. The electronic emitter 202 includes a top flange 206 mounted to the door jam 204 and a backing member 208. A retainer flange 210 extends out from the backing member 208. A printed circuit board 212 is mounted to the retainer flange 210 and is oriented to project an infrared beam downward to form a curtain 214. The curtain 214 covers a substantial portion of the passageway underneath the door jam 204.

When the dispenser assembly 10 including the electronics unit 72 passes the electronic emitter 202, i.e., when someone wearing the dispenser assembly 10 walks through the curtain 214, the electronic emitter 202 transmits the signal to the dispenser assembly 10. The sensor 80 senses the signal and the controller 78 processes the signal to generate the reminder alert, which as mentioned above can be one or more of the light, the audible alarm, and the vibration. Upon sensing the reminder alert, the user presses down on the depression button 58 of the container 14 to dispense a metered dose of the fluid. It is only upon the dispensing of the metered dose of fluid that the reminder alert will be terminated. The downward projection of the signal by the electronic emitter 202 prevents a false alarm as the user must actually enter the room and break the curtain 214 to initiate the reminder alert. The electronic emitter 202 also includes a light source 216. The electronic emitter 202 produces an intermittent beeping noise and a flashing light to indicate that the battery of the existing printed circuit board 212 is low. In response, a new battery can be installed or a new printed circuit board 212 with a new battery may be mounted to the retainer flange 210.

In another embodiment, the electronic emitter 202 could provide non-overlapping first curtain A and second curtain B to control the particular situations under which the reminder alert will be initiated. For example, the system 200 could be set such that when a user wearing the dispenser assembly 10 walks into the room and breaks the first curtain A and then the second curtain B, the controller 78 will receive a corresponding signal to produce the reminder alert.

But when the user wearing the dispenser assembly 10 exits the room and breaks the second curtain B then the first curtain A, the controller 78 will not produce the reminder alert. This serves to reduce unnecessary reminder alerts that could annoy a user. On the other hand, it is appreciated that certain medical facilities may want the reminder alert triggered as the user both enters and exits the room to prevent any bacteria obtained during examination from being transmitted outside the examining room. Therefore, the electronic reminder and data collection system 200 includes the option of providing the reminder alert upon entering the room, or upon entering and exiting the room.

In an alternative embodiment, the electronic emitter 202 may include a wire 218 that is mounted to surround a door, as shown in FIG. 8B, and connected to a power source (which eliminates the need to exchange batteries). As described above, when the dispenser assembly 10 including the electronics unit 72 breaks the infrared or RF signal, i.e., when someone wearing the dispenser assembly 10 walks through the open doorway, the dispenser assembly 10 produces the reminder alert, which will continue until the user dispenses the metered dose of the fluid from the dispenser assembly 10.

In another embodiment (shown in FIG. 8C), the electronic emitter 202 may be configured for use with a power source 220, such as an electrical outlet, or may be positioned in any of various locations within a room. Thus, when a user wearing the dispenser assembly 10, including the electronics unit 72, enters the room and comes into the range of the signal from the electronic emitter 202, the controller 78 will initiate the reminder alert which will remind the user, in this case a medical practitioner, to dispense the fluid before interacting with a patient.

In another alternative embodiment, the reminder alert can be programmed for certain intervals, dates, or times. For example, the reminder alert may be programmed to go off just before the lunch hour to remind school children to dispense a particular fluid, such as a disinfectant. In another example, the reminder alert may be programmed to go off just before a scheduled surgery to remind a medical practitioner to dispense the particular fluid. To ensure use of the dispenser assembly 10, the reminder alert is terminated only when the metered dose of fluid is dispensed by the dispenser assembly 10.

As mentioned above, the dispenser assembly 10 may also include the warning alert to notify the user when the fluid level in the container 14 is low. The warning alert could be a light, an audible alarm, or a vibration that is different from the reminder alert.

In still another embodiment, the dispenser assembly 10 functions as a locating device, which is especially useful for finding children, pets, or objects that are lost. The dispenser assembly 10 may include a GPS location device 94 for determining location information associated with the dispenser assembly 10. The GPS location device 94 includes a GPS antenna and periodically performs a GPS routine to determine the longitude and latitude of the dispenser assembly 10. The controller 78 receives or retrieves the location information and stores the location information in the memory 84. The dispenser assembly 10 continuously transmits the location data to a server 300 via a radio link.

The electronic data collection and reminder alert system 200 may include the electronics unit 72 with the additional capability of allowing the monitoring of usage per hour, time and date of usage, location of usage, unit of usage, and any of a variety of additional data via radio transmission. Each dispenser assembly 10 would be assigned a unique code that corresponds to an individual, and data associated with the unique code could be provided to a participating hospital or corporation. Thus, the electronic reminder and data collection system 200 may be configured to transmit date, time, and use location corresponding to a unique code which identifies the particular dispenser assembly 10 to a server 300. The server 300 runs a computer program 302 which converts the received data into reports that detail the date, time, location of use, and additional information of the dispenser assembly 10 for the individual identified by the unique identifying code. The reports and/or data can be transferred to a computer network 304 and accessed by a personal computer 306. Thus, the electronic data collection and reminder alert system 200 allows an organization to collect valuable data that can be used to measure the effectiveness of the reminder alerts provided by the dispenser assembly 10, substantiate the use of the dispenser assemblies 10, and improve upon the program for future applications. Further, electronic records could be kept for a medical practitioner's appointments via a custom software application and monitoring system. As a result, data could be provided which compares usage to the electronic files and appointments to determine the frequency and adequacy of use of the dispenser assembly 10.

It is further appreciated that the specific functions of the dispenser assembly 10 will vary depending on the user. For example, the dispenser assembly 10 may include a locator and reminder alert for use by children, while the dispenser assembly 10 for medical use would include infrared/blue tooth/hard wired reminders for medical practitioners and also become a disinfectant carrier with a beeper incorporated into the carrier so that medical practitioners will avoid having to wear two devices. These function options could be selected on the electrical panel by special programming and/or the use of dip switches to turn on the options specifically required for the particular unit.

Referring back to FIGS. 3 through 6, the dispenser assembly 10 includes a clip assembly, generally indicated at 100, to allow for attachment of the dispenser assembly 10 to a user's waist belt or the like. The clip assembly 100 includes mounting arms 102, 104 extending out from the outboard surface 67 of the back wall 18. A post 108 extends through the mounting arms 102, 104. A clip 110 rotates about the post 108 to move the clip assembly 100 between a closed position, shown in FIG. 5, and an open position. The clip 110 includes an upper end 112 and a lower end 114. The lower end 114 in one embodiment is generally U-shaped. A biasing member 116 is secured to the post 108 for biasing the clip assembly 110 towards the closed position. The biasing member 116 includes ends that abut the back wall 18 and the clip 110 respectively.

In one embodiment, the main housing 12 along with the container 14 secured thereto may rotate relative to the clip assembly 100 about a base portion 122, as shown in FIG. 5. Thus, a user wearing the dispenser assembly 10 in the standard upright vertical position, i.e., with the depression button 58 forming the uppermost surface of the container 14, may rotate the main housing 12 and container 14 relative to the clip assembly 100 approximately 45 to 90 degrees up to a generally horizontal position such that the depression button 58 is now located along one side of the dispenser assembly 10. As a result, the depression button 58 is less susceptible to contact from a user's stomach, thereby reducing the possibility of accidental dispensing of fluid. It is further appreciated that the user could rotate the main housing 12 and container 14 to any of numerous use positions from the standard upright vertical position. The base portion 122 may include a click mechanism that clicks into place to let the user know that the main housing 12 and container 14 are in one of various predetermined positions.

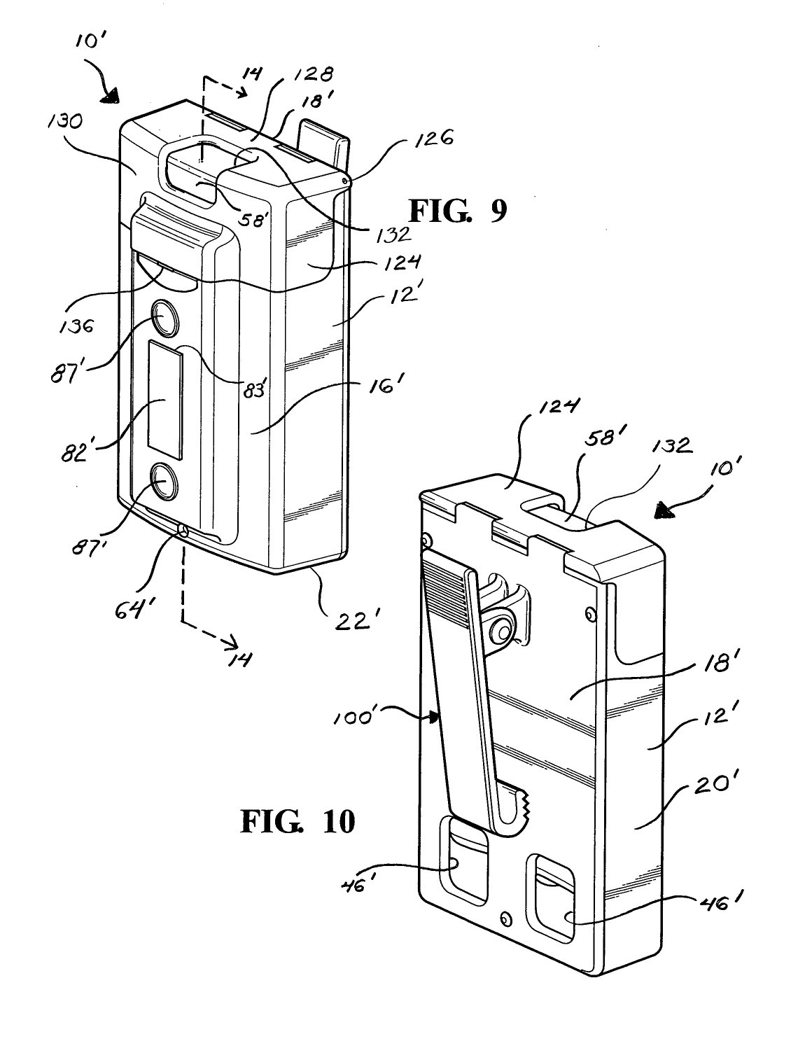

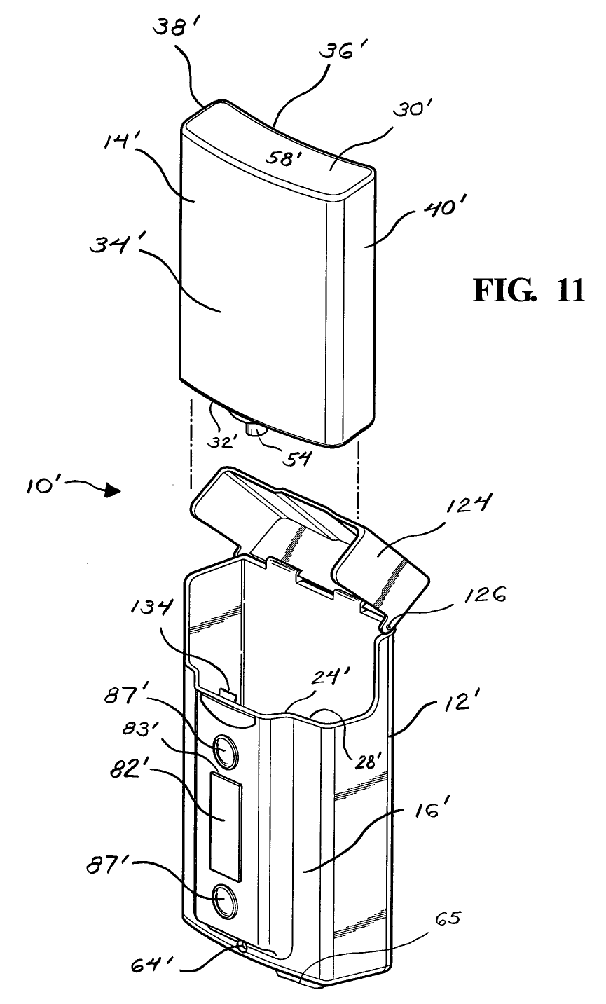

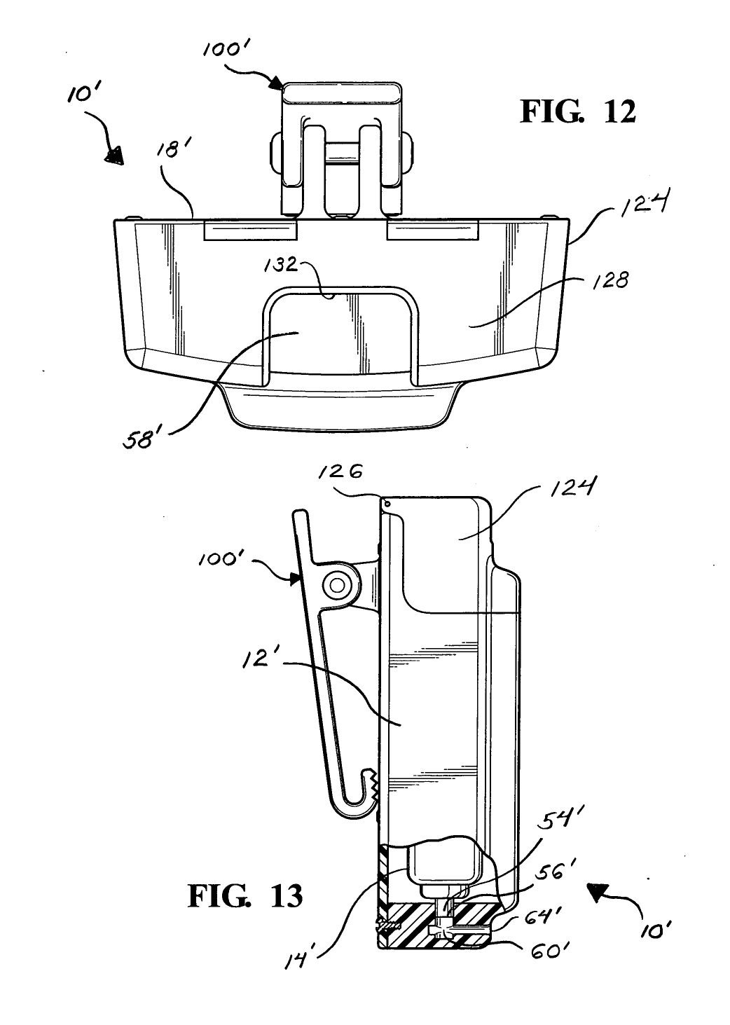

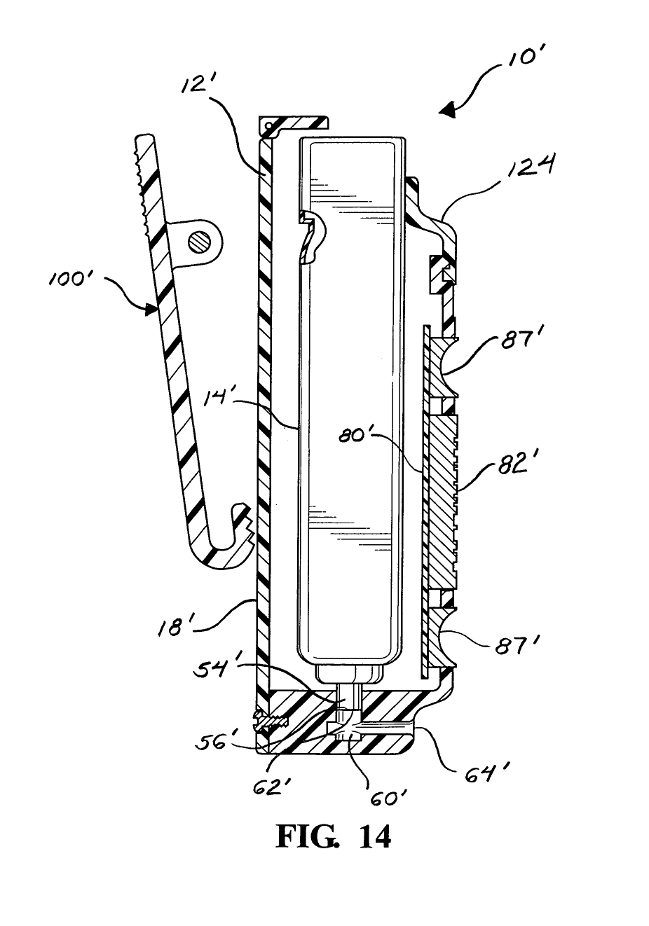

Referring to FIGS. 9 through 14, wherein like primed reference numerals represent similar elements as those set forth above, the dispenser assembly 10′ in a second embodiment of the invention includes the main housing 12′ and a lid 124 pivotally secured thereto about a hinge 126. It is appreciated that the particular size and shape of the main housing 12′ may vary. The lid 124 includes a top surface 128 and a front surface 130. The lid 124 defines a window opening 132 extending through a portion of the top 128 and front 130 surfaces. The lid 124 also includes a coupling portion (not shown) which is engageable with a locking tab 134 formed along the upper edge 24′ of the front wall 16′ of the main housing 12′ in order to maintain the lid 124 in a closed position, shown in FIGS. 9 and 10. The lid 124 further includes a release tab 136 that can be pulled to move the lid 124 from the closed position to an open position, shown in FIG. 11.

The container 14′ is filled with fluid as described above and is removably disposed within the cavity 28′ of the main housing 12′. When the lid 124 is closed, the container 14′ is securely held inside the cavity 28′. And when the lid 124 is opened, the container 14′ may be removed and replaced with a new container 14′. In one embodiment, the container 14′ is a pressurized canister that is well-known to those of ordinary skill in the art. The container 14′ includes the stem 54′ with the open end 56′. The stem 54′ is in fluid communication with the nozzle 60′, which is integrally formed with the main housing 12′. The nozzle 60′ includes the fluid discharge aperture 64′. When the user presses downwardly on the depression button 58′, a predetermined amount of the fluid within the container 14′ will be expelled out of the fluid discharge aperture 64′.

The window opening 132 of the lid 124 allows users to access the underlying depression button 58′. The positioning of the depression button 58′ underneath the window opening 132 prevents users from accidentally dispensing fluid from the dispenser assembly 10′. More specifically, a user must place their finger through the window opening 132 to press the depression button 58′ and dispense the disinfectant. In another embodiment, the lid 124 may cover the corners of the container 14′ while defining an opening that exposes the depression button 58′. By covering the corners of the container 14′, it is more difficult for the user to inadvertently press the depression button 58′ with their stomach, elbow, and the like. In yet another embodiment, a robust spring is associated with the nozzle 60′ such that a greater amount of pressure is required to press the depression button 58′ and activate the dispenser assembly 10′. This embodiment eliminates the problem of inadvertently operating the dispenser assembly 10′ via only the application of mild pressure.

In an alternative embodiment, the container 14′ may include a convex protrusion or button-like protrusion formed in a concave bottom portion that is pushed to dispense the fluid. This prevents inadvertent operation of the dispenser assembly 10′ by positioning the activation mechanism at the bottom of the dispenser assembly 10′. The button on the lid 124 may embossed or inset so that it will not be accidentally pushed. In another embodiment, the dispenser assembly 10′ has a flat bottom cover over a concave container 14′ to have an object to push. The concave shape would move the surface of the container 14′ further from the surface of the main housing 12′, thus making it difficult to push the container 14′. In yet another embodiment, a tab is positioned at the top of the main housing 12′ to assist in pushing the container 14′.

It is contemplated that the container 14′ may include a honeycomb center, a multi-layer laminate, or an internal bladder to withstand any pressure required to maintain the shape of the container 14′. In an alternative the container 14′ may include a refill port such that the container 14′ can be refilled with fluid using a larger pressurized container.

The main housing 12 includes at least one flange to provide an interference fit of the container 14′. In one embodiment, the at least one flange is formed from a soft material and/or liner, such as mole skin or flocking material, to prevent scratching of the container 18. In one embodiment, the inner walls of the main housing 12′ may be coated in a soft material or liner in order to prevent the main housing 12′ from scratching the container 14′.

The invention has been described in an illustrative manner. It is to be understood that the terminology, which has been used, is intended to be in the nature of words of description rather than of limitation. Many modifications and variations of the invention are possible in light of the above teachings. Therefore, within the scope of the appended claims, the invention may be practiced other than as specifically described.

What is claimed:

1. A dispenser assembly for dispensing disinfectant to a user upon the detection of a signal, said dispenser assembly comprising:
a main housing defining a cavity;
a container disposed within said cavity and releasably secured to said main housing, said container containing fluid therewithin; and
an electronics unit coupled to said main housing and including a sensor for detecting the signal, said electronics unit including a controller for producing a reminder alert in response to the detection of the signal to remind the user to activate said dispenser assembly to dispense fluid from the container.

2. The dispenser assembly as set forth in claim 1 wherein said main housing includes a flange defining a chamber for receiving said electronics unit therein.

3. The dispenser assembly as set forth in claim 1 wherein said main housing includes a light source disposed along a bottom wall, said light source one of an infrared or ultraviolet light for detecting the cleanliness of a user's hands.

4. The dispenser assembly as set forth in claim 1 wherein said container includes a depression button for dispensing fluid from said container.

5. The dispenser assembly as set forth in claim 4 including a lid pivotally secured to said main housing to prevent release of said container from said main housing.

6. A dispenser assembly as set forth in claim 5 wherein said lid defines a window opening extending therethrough to provide access to said depression button for activating said dispenser assembly.

7. A dispenser assembly as set forth in claim 1 wherein said electronics unit includes a printed circuit board disposed within said chamber.

8. A dispenser assembly as set forth in claim 1 including a LED display connected to said controller for displaying at least one of alphanumeric characters, graphics, and images.

9. A system comprising:
an electronic emitter adapted to be mounted in a fixed location, said electronic emitter generating a signal; and
a dispenser assembly including a main housing and a container filled with fluid, said main housing defining a chamber for receiving an electronics unit having a sensor for sensing said signal from said electronic emitter, said electronics unit also including a controller for producing a reminder alert in response to the sensing of said signal to remind a user to dispense fluid from the container.

10. The system as set forth in claim 9 wherein said reminder alert produced by said controller is only terminated by the dispensing of fluid from said container.

11. The system as set forth in claim 9 wherein said electronic emitter is mounted to a door jam to produce a signal in the form of a curtain underneath the door jam.

12. The system as set forth in claim 9 wherein said electronic emitter is mounted to a door jam to produce a pair of signals in the form of a first curtain and a second curtain underneath the door jam.

13. The system as set forth in claim 12 wherein passing said dispenser assembly through said first curtain before said second curtain produces said reminder alert and passing said dispenser assembly through said second curtain before said first curtain does not produce said reminder alert.

14. The system as set forth in claim 12 wherein passing said dispenser assembly through said first curtain before said second curtain produces said reminder alert and passing said dispenser assembly through said second curtain before said first curtain produces said reminder alert.

15. The system as set forth in claim 9 wherein said electronic emitter is coupled to a power source and produces a radio frequency signal that is detectable by said sensor of said dispenser assembly in order to produce the reminder alert.

16. The system as set forth in claim 9 including a server operably coupled to said dispenser assembly to receive data from said controller regarding the time, date, and location of usage of said dispenser assembly for each reminder alert that is produced.

17. The system as set forth in claim 9 wherein said electronics unit includes a GPS location device for transmitting location information of said dispenser assembly to said controller.

18. A method for reminding a user to dispense fluid from a portable dispenser assembly including a main housing, a container filled with fluid and having a depression button, an electronics unit including a sensor, and an electronic emitter producing a signal, the method comprising the steps of:
activating the electronic emitter to generate the signal;
sensing the signal with the sensor of the portable dispenser assembly;
generating the reminder alert to remind the user to dispense the fluid from the dispenser assembly;
pressing the depression button to dispense the fluid; and
terminating the reminder alert once the fluid has been dispensed.

19. The method as set forth in claim 18 wherein the step of terminating the reminder alert once the fluid has been dispensed occurs immediately after the step of pressing the depression button to dispense the fluid.

20. The method as set forth in claim 18 including the step of generating data associated with the date, time, and location of use of the dispenser assembly for each reminder alert that is produced.

21. The method as set forth in claim 20 including the step of transmitting the data associated with the date, time, and location of use of the dispenser assembly to a server.

22. The method as set forth in claim 21 including the step of converting the data to a report that is viewable on a computer.

23. The method as set forth in claim 18 including the step of determining the location of the dispenser assembly using a GPS location device.

24. The method as set forth in claim 23 including the step of continuously transmitting information related to the location of the dispenser assembly to a server.
